(19) United States
(12) Patent Application Publication
(10) Pub. No.: US 2008/0098778 A1
(43) Pub. Date: May 1, 2008

(54) Locking Device

(76) Inventor: Vladimir Georgievich Skrobot, Moscow (RU)

Correspondence Address: NOTARO AND MICHALOS, 100 DUTCH HILL ROAD, SUITE 110, ORANGEBURG, NY, 10962-2100, US

(21) Appl. No.: 11/722,963

(22) PCT Filed: Jan. 10, 2006
(86) PCT No.: PCT/RU06/00008

§ 371 Date: Aug. 27, 2007

(30) Foreign Application Priority Data
Dec. 31, 2004 (RU) 2004138992

(51) Int. Cl. E05B 17/14; E05B 27/04

(52) U.S. Cl. 70/344

(57) ABSTRACT

The invention relates to locking devices for doors in office facilities and domestic premises, for safes and etc. The device contains the key, housing with keyhole, reciprocating ram, locking module and at least one deadlock has new conditions. The control unit interacts with reciprocating ram and key extractor interacts with control unit. The reciprocating ram is mounted under the condition of its overlap of the keyhole and interaction with the control unit. A locking assembly unit is executed in the form of fixed and movable against the housing locking modules interacting between each other. Fixed locking module has code overhangs suitably matched to the code openings and/or key deepening. Extractor positioning provides a means for key moving during lock opening from the ram slot to the position of contact with mentioned code overhangs. The position of movable locking module provides a means for its interaction with at least one spar piece with the help of control unit. Technical decision of this invention due to elimination of free accessibility to coding elements of the lock from the part of unauthorized persons as well as usage of counterfeit keys will increase operational functions of the device.

The invention relates to locking devices for doors in office facilities and domestic premises, for safes and etc.

Following from the prior art the locking device is known under the patent SU 1792478 that was suggested as the closest prior art and contains a case with a keyhole fixed on the lock housing, carrier interacting with the case and controlled by holding selvedge and extractable key. The case has a flat bottom, the key and the carrier has a form of flat plates that bear against each other; their end sections are disposed in the case and make it possible for the carrier to interact with the case bottom along contact plane. The key and the carrier of the mechanism are located crosswise against each other. The mechanism has a couple of seatings every of each is composed of uniaxial bores of the carrier and the bottom and pairs of resilient pins positioned in every seating. The first pin has the length that is equal to the thickness of the carrier while the length of the second pin builds up the sum of key and carrier thicknesses. The key is provided at least with one opening that coincides with the seating of the mechanism bearing the bigger pin from the above mentioned.

The possibility of easy access to coding elements through the keyhole forms the main disadvantage of the prior art and other well-known devices. This fact enables manipulation with locking elements of the coding mechanism by picklock and similar instruments in case of unauthorized door or safe opening. The suggested structure doesn't contain the indicated disadvantage while the coding elements of the lock are hindered and extreme high security is explained by immense quantity of coding element combinations—more than 2⁶⁰ variations.

Technical decision that could be achieved after implementation of this invention due to elimination of free accessibility to coding elements of the lock from the part of unauthorized persons as well as usage of counterfeit keys will increase operational functions of the device.

The technical decision of the suggested locking device that contains the key, housing with keyhole, reciprocating ram, locking module and at least one deadlock has new conditions. The advanced locking device is additionally provided with control unit interacting with reciprocating ram and key extractor interacting with control unit. In reciprocating ram there is a slot for a key disposed under the condition of its opposite position toward keyhole and the reciprocating ram is mounted under the condition of its overlap of the keyhole and interaction with the control unit. A locking assembly unit is executed in the form of fixed and movable against the housing locking modules interacting between each other. At that the fixed locking module has code overhangs suitably matched to the code openings and/or key deepening. Extractor positioning provides a means for key moving during lock opening from the ram slot to the position of contact with mentioned code overhangs and the position of movable locking module provides a means for its interaction with at least one spar piece with the help of control unit.

Besides it is possible to implement this invention in particular cases. In accordance with these cases key slot in reciprocating ram is executed under the condition of its contact with the key on the ending side surfaces of the slot, the extractor is executed under the condition of its going along contact surfaces of the slot with a light tension. The device can additionally include stopping mechanism of the key spring-actuated toward the housing with the position between reciprocating ram and fixed locking module and appliance for moving of spar pieces in different directions connected with the control unit.

The invention is illustrated by drawings.

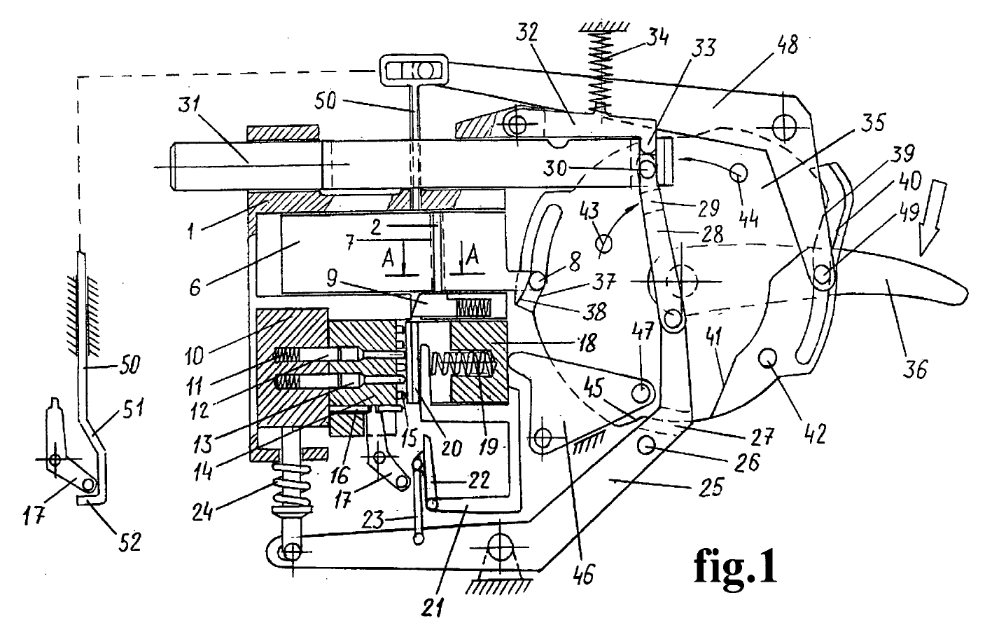

On the FIG. 1 there is a general view of the locking mechanism in closed position,

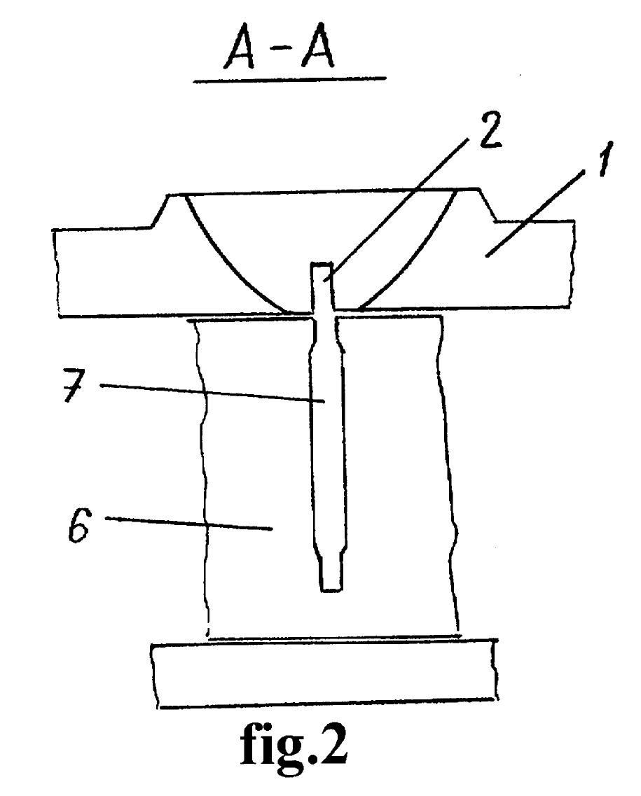

FIG. 2 represents section A-A of the FIG. 1;

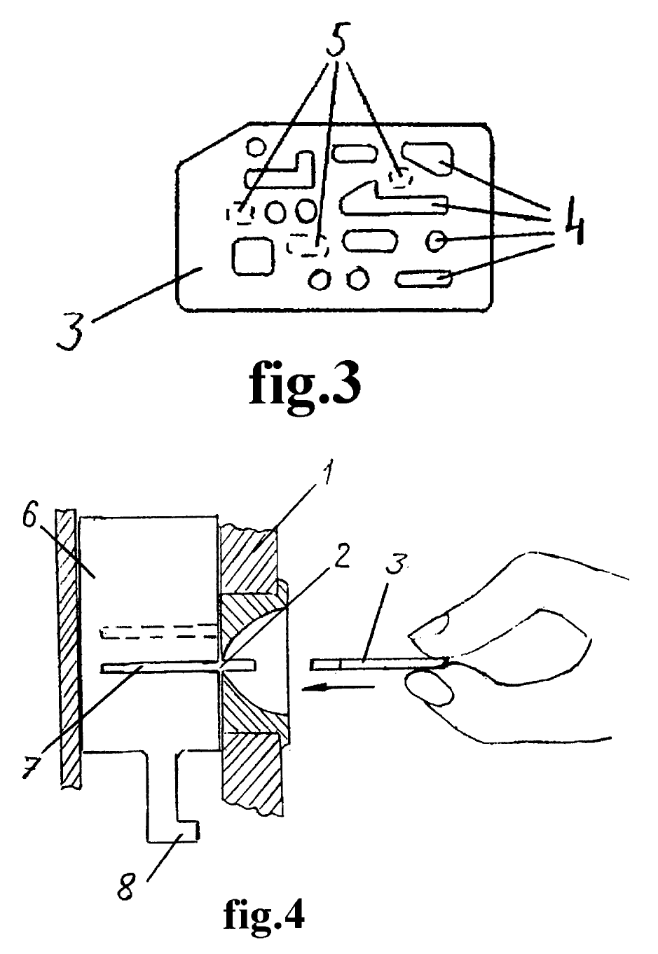

FIG. 3 contains a general view of the lock key; the

FIG. 4 represents the process of key setting in the keyhole; on the

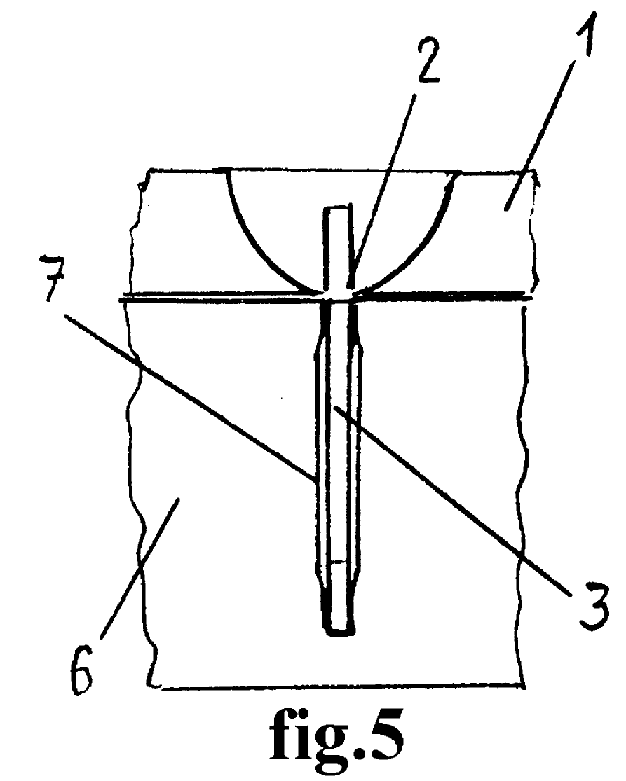

FIG. 5 there is key position inside the keyhole;

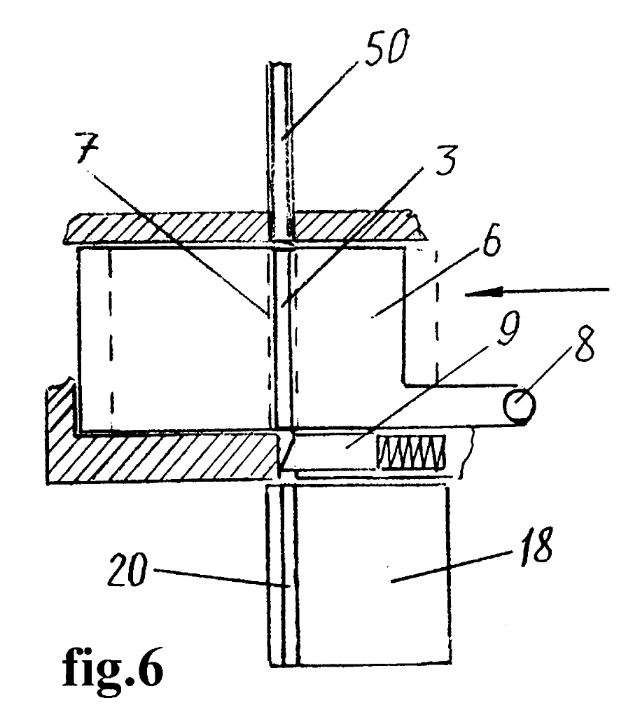

FIG. 6 represents the position of separate elements of the lock during opening;

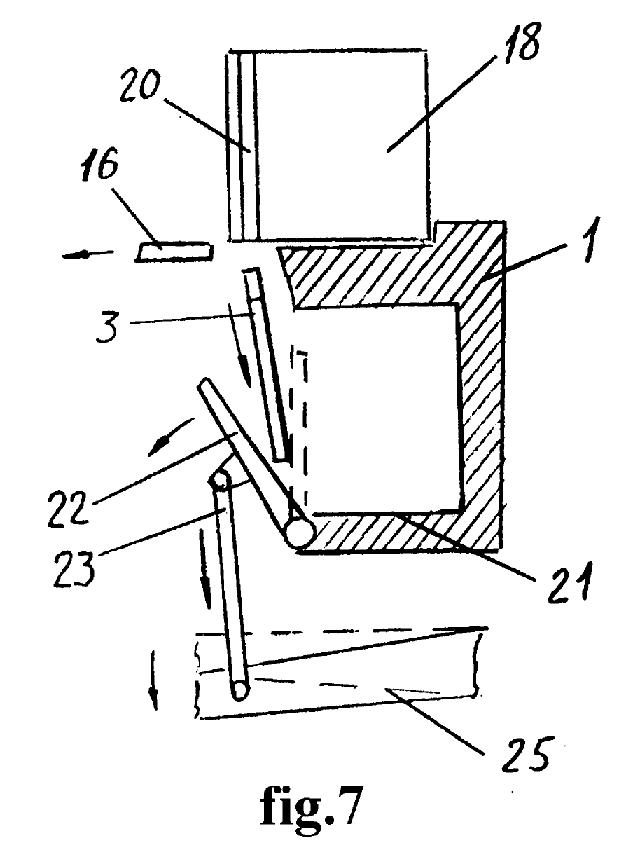

FIG. 7 introduces a general view of internal key box; the

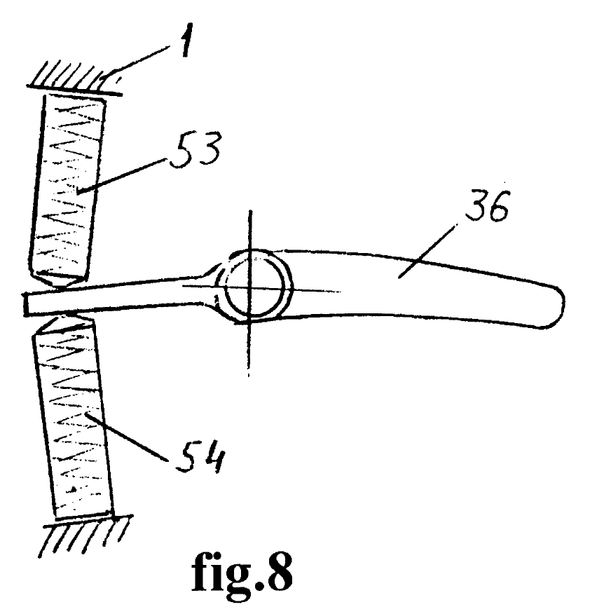

FIG. 8 shows one of the preferred variants of lock knob installation.

The lock includes housing 1 with the keyhole 2, reciprocating ram 6 that has profiled slot 7 for the key 3 and the overhang 8 interacting with the control unit that in described invention embodiment is made as cammed unit 35, fixed locking module 14 fixed inside the housing 1 with code overhangs 15 that are matched to code openings 4 and code deepenings 5 of the key 3 containing set of step-like holding selvedges 13, interacting with it movable locking module 10 forced out by the spring 24 toward the intermediate lever 25 containing set of spring-actuated locking holding selvedges 12 that are uniaxial with step-like holding selvedges 13, the sliding clamp 18 activating by cammed unit 35 and containing key slot 20, spring-actuated key stopping mechanism 9, movable under-key plate 16, the box 21 for the used key having cutoff plate 22 and activating from intermediate lever 25 by the traction 23, the cammed unit 35 operating the lock mechanism and put into motion from the outside lock knob 36, the spar piece 31 (or several spar pieces) actuated from the overhang 43 of the cammed unit 35 by the lever 28 that during lock opening is connected with the intermediate lever 25 and during lock closing is connected with the overhang 44, actuated by the cammed unit 35 with the help of the lever 48 provided with the cams 51 and 52 for the driver of the under-key plate 16 by the lever 17 the profiled key extractor 50 having spring-activated by the spring 34 fixing device 32 with the overhang 33 for spar piece blocking when the lock is in closed position and for partial fixation when the lock is in open position.

The lock mechanism works as follows. In closed position the spar piece 31 is pulled out from the housing 1 to the maximum and fixed by the overhang 33 of the fixing device 32. The profiled key slot 7 of the reciprocating ram 6 coincides with the keyhole 2 (FIG. 2). The spring-activated holding selvedges 12 of the movable locking module 10 are coming into uniaxial openings of the fixed locking module 14 under the action of the springs 11 shifting the step-like holding selvedges 13 inward the locking module 14 as far as they will go, thereby preventing shifting of the module 10 under the influence of the spring 24. At that the lever driver of the spar piece 28 and connected to it intermediate lever 25 are fixed in down position. It hinders the influence on the locked spar piece 31 by turn of the cammed unit 35 across the lock knob 36 since firstly the rotation angle of the unit 35 is confined by limit stop of overhang 42 toward the intermediate lever 25 and secondly the corresponding slot 29 of the lever 28 is located on rotation radius of the overhang 43 of the spar piece 31 unlatch.

For lock opening it is necessary to insert the key 3 from outside through the keyhole 2 into the profiled slot 7 of the ram 6 against the stop in a certain manner (FIG. 4). The splay of the key 3 must be faced forward and upward, in the direction of the response overhang of the profiled slot 7. Otherwise the key will not completely come into the keyhole 2. Inside the slot 7 the key 3 touches the slot walls in several points along the key ends. The most part of the key 3 surfaces has small clearance against the walls of the profiled slot 7 (FIG. 5). It helps the key not to leave contact traces from code openings 4 and code deepenings 5 on the walls of the profiled slot 7.

The next step in lock opening is the turn from outside the lock knob 36 toward the direction indicated by arrow on the FIG. 1 overcoming the force of the return spring 53 (FIG. 8). At that the cammed unit turns. Firstly the cam 37 is activated. Through the overhang 8 of the reciprocating ram 6 the shifting ram together with the key 3 positioned in the slot 7 is moving toward the key extractor 50 until the slot 7 would coincide with the plane of the extractor 50 (FIG. 6). At that the keyhole 2 in the housing 1 is completely covered by tightly fitted front surface of the reciprocating ram 6. It closes the entering into the labyrinth where the key 3 is moved and is kept closed during the whole process of lock working up till the lock knob 36 will take start position. The whole process prevents the opening of coding elements by picklock. If the cammed unit 35 is turned further, the overhang 8 of the ram 6 slides along the cylindrical surface of the unit 3 without influence upon the reciprocating ram.

Then the cam 39 is activated. Pushing the overhang 49 of the lever 48 it rotates the lever about axis and through this drives the key extractor 50 that with minimum clearance enters into the profiled key slot 7 of the ram 6 and forces the key 3 through the spring-actuated stopping mechanism 9 shifting it into the key slot 20 of the sliding clamp 18. When the key 3 is completely entered into the slot 20, the stopping mechanism takes the previous position under the influence of its spring. Inside the key extractor 50 there is a response mortise and it doesn't hinder the moving of the stopping mechanism at all. That prevents pulling of the key or its substitute with impression print of the code overhangs 15 in the fixed locking module 14 outside from the keyhole 2. After lock opening the original key will remain in internal key box 21 and the key that is foreign for this mechanism after ineffectual effort of lock opening will fall inside the door or the safe.

Simultaneously with extrusion of the key 3 from the key slot 7 on ram 6 the cam 51 situated on extractor 50 turns about axis the lever 17 that shifts movable under-key plate 16 toward sliding clamp 18 covering the key 3 way out from the key slot 20 of the clamp 18. So the key 3 in key slot 20 is held by extractor 50 on the one side and by movable under-key plate 16 on the other side. Then the cam 41 is to be activated. Shifting the overhang 47 of the lever 46 it turns the lever about axis and by pressing the spring 19 moves the sliding clamp 18 with the key 3 situated it its slot 20 toward the fixed locking module 14. If the key is original then the code overhangs 15 of the module 14 are coming into the corresponding code openings 4 and code deepenings 5 of the key 3. At that the sliding clamp 18 tightly presses the key 3 to the plane of the module 14 faced to the clamp completely sinking step-like holding selvedges 13 that during spring compressing are shifting the spring-actuated holding selvedges 12 by butt ends exactly up to contact plane of the movable locking module 10 and movable locking module 14 and thereby release the module 10 that is immediately shifted under the influence of the spring 24 in the direction of the intermediate lever 25 turning it about axis.

If unauthorized people use a false key it is next to impossible that the key plate would exactly adjoin to the plane of the fixed locking module with simultaneous process of correct pressing upon all the holding selvedges and release of movable locking module. The lock would not be unlatched. At that the slot 27 of the intermediate lever 25 is coincided with the overhang 42 of turn limit in cammed unit 35 and enables the unit 35 to be turned further during the lock opening. The lever 28 of the spar piece driving that connected with the intermediate lever 25 by its overhang pushes the overhang 33 of the fixing device 32 from the spar piece slot 31 releasing this spar piece. The slot 29 of the lever 28 is shifted from the overhang 43 of spar piece 31 unloosening and enables the overhang 43 to influence upon the lever 28. The further turn of the cammed unit 35 makes the overhang 42 to go through the slot 27 of the lever 25 not preventing the unit turn and the overhang 43 is pressing on the lever 28 of the spar piece driving while that by its overhang 30 is moving the spar piece 31 inside the housing 1 thereby opening the lock.

The intermediate lever 25 that during lock unlatching is turning about axis opens the cutoff plate 22 of the internal key box 21 with the help of the traction 23 (FIG. 7).

In opened lock position the spar piece 31 is partially clamped since the overhang 33 of the fixing device 32 is entering into small deepening of the spar piece.

After force release from the lock knob 36 under the influence of the return spring 53 it will take base position. At that the retrieval of the lock elements happens in reverse order. During back rotation of the cammed unit 35 the cam 41 releases the sliding clamp 18 that under the influence of the spring 19 takes the start position in the plane of the extractor 50 up to the stop against the housing 1 and removes the key 3 from the code overhangs 15 of the fixed locking module 14. Then by the overhang 49 the cam 40 will turn the lever 48 that pulls out the extractor from the profiled slot 7 of the ram 6 in the housing 1 releasing the ram. Simultaneously the extractor 50 with the help of the cam 52 turns the lever 17 that slides the under-key plate 16 into its place releasing the key 3 that under the influence of its sole weight is falling from the slot 20 of the sliding clamp 18 and if the cutoff plate is open it gets into the internal key box 22. In the event that foreign key is used the lock wouldn't open and the cutoff plate of the box 21 remains closed. In this case after having opened the key slot 20 of the under-key plate 16 the false key will fall past the box 21 inside the door signaling about lock tamper.

The cam 38 is activated at the end. It recovers the start position of the reciprocating ram 6 in which the keyhole 2 gets open and fits together with the slot 7 of the ram 6. At that the lock knob 36 would take the previous position.

Locking is carried out by light moving of the lock knob in the direction that is opposite to unlatching. The cammed unit 35 actuating by the knob 36 will overcome the force of the return spring 54 and with the help of its cam 45 that influences on the overhang 26 of the intermediate lever 25 will turn it about axis pressing the spring 24 and returning the movable locking module 10 in start position in which the openings of holding selvedges are uniaxial. Under the influence of the spring 11 the spring-actuated holding selvedges 12 will shift the step-like holding selvedges 12 inside the fixed locking module 14 against the stop and block by themselves the immovable locking module 10. Simultaneously the overhang 44 is influencing directly on the spar piece 31 and pushing it out from the housing 1 into the deep slot of the spar piece 31 till it would be locked by the overhang 33 of the fixing device 32. The spar piece is pulled out from the housing and fixed. The lock is latched and after this the lock knob 36 together with the cammed unit 35 will take the start position by force or under the influence of the return spring 54.

1. Locking device contains the key, housing with keyhole, reciprocating ram, locking module and at least one deadlock has new conditions. The advanced locking device is additionally provided with control unit interacting with reciprocating ram and key extractor interacting with control unit. In reciprocating ram there is a slot for a key disposed under the condition of its opposite position toward keyhole and the reciprocating ram is mounted under the condition of its overlap of the keyhole and interaction with the control unit. A locking assembly unit is executed in the form of fixed and movable against the housing locking modules interacting between each other. At that the fixed locking module has code overhangs suitably matched to the code openings and/or key deepening. Extractor positioning provides a means for key moving during lock opening from the ram slot to the position of contact with mentioned code overhangs and the position of movable locking module provides a means for its interaction with at least one spar piece with the help of control unit.

2. According to the article 1 the device differs in having the key slot in the ram that is executed under the condition of its contact with the key on the ending side surfaces of the slot.

3. According to the article 2 the device differs in having the extractor that is executed under the condition of its going along contact surfaces of the slot with a light tension.

4. According to the article 1 the device differs in having an additional stopping mechanism of the key spring-actuated toward the housing disposed between the ram and the fixed locking module.

5. According to the articles 1-4 the device differs in having an additional appliance for moving of spar pieces in different directions connected with the control unit.
